(19) United States
(12) Patent Application Publication
(10) Pub. No.: US 2006/0001683 A1
(43) Pub. Date: Jan. 5, 2006

(54) Structure image generation

(76) Inventors: Alexander May, Stoneham, MA (US); Jason Goldstein, Redmond, WA (US)

Correspondence Address: FISH & RICHARDSON PC, P.O. BOX 1022, MINNEAPOLIS, MN, 55440-1022, US

(21) Appl. No.: 11/087,423

(22) Filed: Mar. 23, 2005

Related U.S. Application Data
(60) Provisional application No. 60/578,703, filed on Jun. 10, 2004.

(51) Int. Cl. G09G 5/00

(52) U.S. Cl. 345/661

(57) ABSTRACT

Methods and apparatus, including computer program products, for structure image generation. A network includes a corporate server linked to a building server, devices linked to the building server, a first set of the devices selectively controlling room light emanating to an exterior of a structure from a plurality of rooms within the structure, and a second set of devices selectively controlling lighting fixtures within the plurality of rooms, the first set of devices integrated with the second set of devices.

### CROSS-REFERENCE TO RELATED APPLICATIONS

This application claims priority based on U.S. Patent Application No. 60/578,703 for “GENERATING AN IMAGE”, filed Jun. 10, 2004, the disclosure of which is incorporated here by reference in its entirety.

### BACKGROUND

The present invention relates to data processing by digital computer, and more particularly to structure image generation.

During different times of the year, such as during Christmas and New Years', one can sometimes find buildings displaying decorative designs using selective activation and deactivation of lamps for night viewing. For example, upper floors of a building can be transformed in to a huge display by manually/physically arranging lamps behind the building's windows.

### SUMMARY

The present invention provides methods and apparatus, including computer program products, for structure image generation. In general, in one aspect, the invention features a network including a corporate server linked to a building server, and devices linked to the building server, the devices selectively controlling light emanating to an exterior of a structure from a plurality of rooms within the structure.

The invention can be implemented to include one or more of the following advantageous features. The devices can be window treatments.

In embodiments, the network can include devices controlling lighting fixtures integrated with the devices selectively controlling the light emanating to the exterior of the structure.

The network can include one or more room controllers positioned in a subset of the plurality of rooms and configured to one or more of the devices.

The corporate server can include an input/output (I/O) device for receipt and transmission of data. The corporate server can include a web interface. The corporate server can include a graphical user interface (GUI) for receipt of data. The data can include image data. The image data can represent pixels of light. A pixel of light can represent an activated device allowing light to emanate to the exterior of the structure. A pixel of light can represent an activated lighting fixture.

The data can include temperature data, and time of day data. The data can include historical data. The data can include alert data. The alert data can include data representing an emergency condition within the structure.

The devices can include a manual override. The GUI can include a computer-aided design (CAD) program. Each of the devices can operate over a range of values.

In embodiments, the network can include a verification system linked to the building server. The verification system can include a camera. The camera can be an Internet-enabled digital video camera. The Internet-enabled digital camera can send adjustment data to the building server in response to a comparison of expected image display and actual image display. The Internet-enabled digital camera can send adjustment data to the building server in response to a comparison of an expected image display time and an actual image display time.

The GUI can include an interface for viewing a current state of the exterior of the structure. The current state can include a current image from an Internet-enabled digital video camera and statistics related to generating the current image.

In another aspect, the invention features a network including a corporate server linked to a building server, and devices linked to the building server, the devices controlling light fixtures that emanate light to an exterior of a structure from a plurality of rooms within the structure.

The invention can be implemented to include one or more of the following advantageous features. The network can include devices controlling light emanating to the exterior and integrated with the devices controlling the light fixtures. The devices controlling the light emanating to the exterior can be window treatments.

In embodiments, the network can include one or more room controllers positioned in a subset of the plurality of rooms and configured to control one or more devices. The corporate server can include an input/output (I/O) device for receipt and transmission of data. The corporate server can include a web interface. The corporate server can include a graphical user interface (GUI) for receipt of data. The data can include image data. The image data can represent pixels of light. A pixel of light can represent an activated device allowing light to emanate to the exterior of the structure. A pixel of light can represent an activated lighting fixture.

The data can include temperature data, and time of day data. The data can include historical data. The data can include alert data. The alert data can include data representing an emergency condition within the structure. The devices can include a manual override.

The GUI can include a computer-aided design (CAD) program. The devices can operate over a range of values.

The network can include a verification system linked to the building server. The verification system can include a camera. The camera can be an Internet-enabled digital video camera. The Internet-enabled digital camera can send adjustment data to the building server in response to a comparison of expected brightness information and actual brightness information.

The GUI can include an interface for viewing a current state of the exterior of the structure. The current state can include a current image from an Internet-enabled digital video camera and statistics related to generating the current image

In another aspect, the invention features a network including a corporate server linked to a building server, devices linked to the building server, a first set of the devices selectively controlling room light emanating to an exterior of a structure from a plurality of rooms within the structure, and a second set of devices selectively controlling lighting fixtures within the plurality of rooms, the first set of devices integrated with the second set of devices.

The invention can be implemented to include one or more of the following advantageous features. The first set of devices can be window treatments.

The network can include one or more room controllers positioned in a subset of the plurality of rooms and configured to control one or more devices. The corporate server can include an input/output (I/O) device for receipt and transmission of data. The corporate server can include a web interface. The corporate server can include a graphical user interface (GUI) for receipt of data. The data can include image data. The image data can represent pixels of light. A pixel of light can represent an activated device allowing light to emanate to the exterior. A pixel of light can represent an activated lighting fixture.

In embodiments, the data can include temperature data, and time of day data. The data can include historical data. The data can include alert data. The alert data can include data representing an emergency within the structure. The devices can include a manual override.

The input/output device can include a computer-aided design (CAD) program. The devices can operate over a range of values.

The network can include a verification system linked to the building server. The verification system can include a camera. The camera can be an Internet-enabled digital video camera. The Internet-enabled digital camera can send adjustment data to the building server in response to a comparison of expected image display and actual image display.

The input/output device can include an interface for viewing a current state of the exterior of the structure. The current state can include a current image from an Internet-enabled digital video camera and statistics related to generating the current image.

In another aspect, the invention features a method including, in a network including a server linked to a plurality of office controllers, the office controllers positioned within a subset of rooms within a structure and linked to one or more devices positioned in a set of rooms, assigning the office controllers as pixels, and selectively controlling a state of each of the pixels in the network.

The invention can be implemented to include one or more of the following advantageous features. An “on” state of a pixel can include an activated lighting device and an activated window treatment device. The method can include previewing an image caused by the pixels in a graphical user interface (GUI). The method can include storing historical information pertaining to an image caused by the pixels. The historical information can include scheduling information and billing information. The GUI can include computer-aided design (CAD) software.

The method can include alternating a display of an image on an exterior of the structure upon input from a verification system. The verification system can be an Internet-enabled digital camera. The Internet-enabled digital camera can send adjustment data to the building server in response to a comparison of expected pixel transition times and actual pixel transition times. The building server can include pattern recognition software.

The method can include controlling the state in response to determining an occupancy of each of the rooms associated with the office controllers.

The method can include controlling the state in response to determining an alert triggered by the associated office controllers. The alert can be a security alarm. can be a fire alarm.

The method can include controlling the state in response to temperature data generated by the associated office controllers and/or in response to historical data.

Selectively controlling the state of each of the pixels in the network can include detecting an occupancy. Detecting an occupancy can include dimming the pixels when occupants can be detected, and brightening the pixels in an absence of occupants being detected. The method can include manually overriding the state.

Selectively controlling the state of each of the pixels in the network can include scheduling information.

Selectively controlling the state of each of the pixels in the network can include detecting faults in the pixels, and altering positions of the pixels to compensate for detected faults.

In another aspect, the invention features a method for generating an image from a building, the image including pixels, the method including generating signals associated with the pixels, sending the signals to offices in the building, an office corresponding to one or more of the pixels, the offices including lighting devices configured to emit light and to receive the signals, and controlling the light emitted from the lighting devices to the exterior of the building based on the signals.

The invention can be implemented to include one or more of the following advantageous features. Controlling the light can include turning on or turning off or dimming the lighting devices. The lighting devices can include window covering devices configured to emit light and to receive the signals, and controlling the light can include opening or closing the window coverings based on the signals. The window covering devices can be electronic shades. The window covering devices can be electronic blinds. The signals can include electrical signals and/or radio signals.

The method can include receiving an input to override the signals, and preventing the signals from being executed based on the input. The input can be based on sensing office occupancy. The input can be made by a user.

The invention can be implemented to realize one or more of the following advantages.

The network uses the interior lights of a building as pixels to display images on the outside of the building. The lights and window treatments (e.g., shades) in a building are placed under remote control using a secure network including both wired and wireless components. In one example, to turn a pixel on, a light is turned on and a window treatment opened. To turn a pixel off, a light is turned off or, if the office is occupied, a window treatment is closed.

Animations can be produced by varying the images rapidly. Electro-chromic glass, organic light-emitting diodes (LEDs), and other similar technologies can be used to produce higher intensity, higher resolution images.

The network conserves energy reducing electricity usage by turning off the lights when offices are unoccupied, and reducing heating and cooling costs by controlling solar heating and cooling using window treatment position.

Occupants have direct access to dimmable lights. Instead of being limited to the standard on/off type of lighting, occupants are able to vary their lighting to match their personal taste.

Depending on the specifics of an installation, the network provides occupants an ability to control individual lights that previously were controlled as a group.

The network provides automatic adjustment. The automatic adjustment of the lights and window treatments to the ambient light and temperature improves occupants comfort.

Maintenance and administrative features of the network ensure that light and window treatment problems are detected early, and fixed swiftly. The occupants endure less burnt out or flickering bulbs and less broken window treatments.

One implementation of the invention provides all of the above advantages.

Other features and advantages of the invention are apparent from the following description, and from the claims.

### DESCRIPTION OF THE DRAWINGS

FIG. 1 is a block diagram.

FIG. 2 is flow diagram.

Like reference numbers and designations in the various drawings indicate like elements.

### DETAILED DESCRIPTION

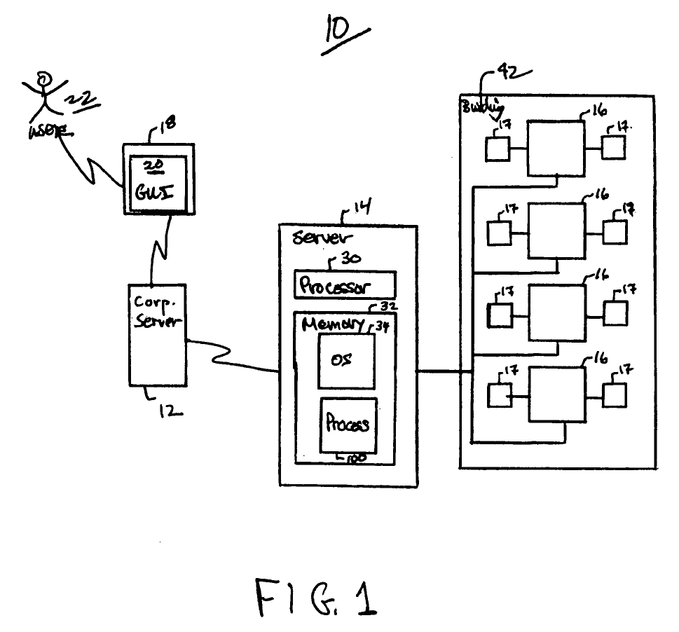

As shown in FIG. 1, an exemplary network 10 includes a corporate server 12 linked to a building server 14. Although the corporate server 12 is shown directly linked to the building server 14, other implementations include the corporate server 12 and the building server 14 linked to a network of interconnected computer systems, such as the Internet. In such other implementations, input received by the building server 14 from the corporate server 12 can be handled locally with a single structure, such as a building, or remotely from most any geographic location.

The building server 14 can be linked to a number of office controllers 16. In a particular example, the office controllers 16 are positioned in a subset of rooms of an office building and communicate with any one or more devices room 17 located in or proximate to a set of rooms. Example room devices 17 can include room lighting devices, room light switch devices, room window treatment devices (e.g., motorized shades), thermostat devices, security alarm devices and so forth. Example rooms include, but are not limited to, offices, closets, foyers, lobbies, and so forth, each having at least a lighting device or a window treatment device. In one implementation, the building server 14 is linked directly to the room devices 17. In another implementation, the building server 14 is directly linked to one or more office controllers 16 and directly linked to one of more room devices 17.

In some implementations, the office controllers 16 and devices 17 can combined into one or more single devices, so that the building server 14 communicates with the devices directly and not through an office controller 16.

The corporate server 12 includes an input/output device 18 having a graphical user interface (GUI) 20 for display to a user 22.

The configuration of network 10 is flexible. For example, in one example, one or more of the office controllers 16 can include one or more intervening controllers linked between the building server 14 and the office controllers 16.

In another example, the network 10 is implemented as a wireless local area network (LAN) or a combination of wireless and wired technologies. A wireless LAN is one in which a mobile user can connect to a LAN through a wireless (radio) connection. One particular standard, IEEE 802.11, specifies the technologies for wireless LANs. In the exemplary configuration shown, network 10 is implemented as a client-server network.

In particular examples, the user 22 on the corporate server 12 interacts with the building server 14 (which in turn activates and deactivates the office controllers 16 that controls specific devices 17) using a web client and hardware devices within the network 10 and are designed, for example, as an ASP.NET eXtensible Markup Language (XML) or Python Web service.

As is described below, the corporate server 12, a client system in the network 10, receives and/or generates input data. The received input can be provided by another system (not shown) or from the user 22 through the GUI 20. The input/output device 18 can include web pages or database management software. The input/output device 18 enables the user 22 to design applications to interface with the corporate server 12. In a particular example, the input data represents an image to be displayed on a building. The input data is sent to the building server 14. In response to the received input data, the building server 14 can cause one or more of the office controllers 16 to become activated or deactivated, thus activating/deactivating specific devices 17. The building server 14 can be instructed to wait for a particular period of time before causing one or more of the office controllers 16 to become activated or deactivated. The building server 14 can be scheduled to cause one or more of the office controllers 16 to become activated or deactivated. In one example, the office controller 16 controls an on/off operation of a room lighting device and/or an opening/closing of a window treatment device, such as a window shade. By controlling a room light device and/or window treatment device, a room can be made to appear as a pixel of light when viewed from an exterior of the building. When the lighting device and/or room shade devices are controlled for a number of rooms, with each room representing a pixel, an image in response to the received input data is generated as viewed from the exterior of the building. In this example, each room corresponds to at least one pixel. Images formed from a combination of the pixels can be text messages or graphics. Images can be changed rapidly, providing for scrolling text and animations.

The building server 14 includes, for example, a processor 30 and a memory 32. Memory 32 includes an operating system (OS) 34, such Linux, Unix or Windows, and a structure image generation process 100, described below. The building server 14 can also include a storage device 36. The storage device 36 can include a database 38 for storing received input used to, for example, generate the image on the exterior of the building.

In one particular implementation, network 10 includes a verification system 40 linked to the building server 14. The verification system 40 is used, for example, to a determine quality of a generated display on the exterior of a building 42. An example verification system 40 is a digital video camera or wireless web camera positioned to view a side of a building exterior exhibiting a generated image.

In other examples, the verification system 40 includes pattern recognition software. The pattern recognition software interprets the generated image and sends the building server 14 corrective signals in an event that the displayed image does not correspond to the desire generated image as defined by the received input data from corporate server 12.

The verification system 40 can be an Internet enabled digital video camera that is installed on a building and has a good visual view of the target building. Before the corporate server 12 and building server 14 are installed, a building can be monitored over several evenings. The natural movements of the building's occupants yield images of each window—lit and unlit.

Windows on the building that change state simultaneously can be identified. These groups represent more than one light controlled by one switch and/or more than one window lit by one light.

These images can be combined with computer aided design (CAD) drawings to generate a model of the building. The model can be used by image generation software to generate and visualize advertisements from various locations, viewing angles, and weather conditions. The advertisements that are generated can be stored in the database 38.

Booked images are images that are assigned a time to be displayed. An animation is a process of booking a series of ads so that they run without interruption. After the network 10 is installed, live images are combined with the model, and the schedule to verify that the network 10 is functioning. The images can be digitally signed and used as proof of service delivery for billing purposes. In one example implementation, a technician connects directly to the verification system 40 to view live images or video. The same mechanism can be available to a salesman who my want to demonstrate a mesage for a customer live.

If the expected and actual images do not match, the network 10 first attempts to automatically remedy the situation. The network 10 logs the failure and notifies a technician if the situation does not correct itself.

A dead or faulty pixel can cause an alternate image, which is not affected by the fault, to be displayed.

In one example, the office controllers 16 include a network access card to connect to the building server 14, a lighting device dimmer device, such as dimmable fluorescent ballast controller to adjust a gradation of light intensity, and window treatment controller devices, such as a motorized shade controller to raise and lower a window shade.

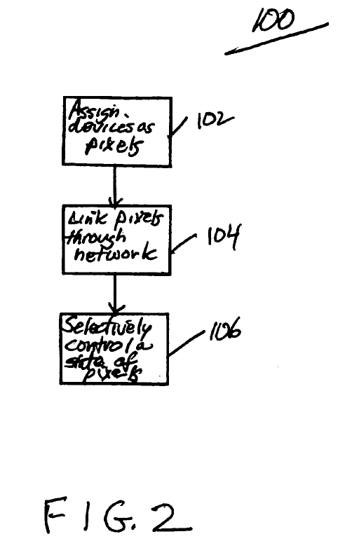

As shown in FIG. 2, process 100 includes assigning (102) a number of lighting devices of a building as pixels to generate images on a building exterior. Example lighting devices are dimmable fluorescent ballast controllers linked with window treatment controllers.

In one particular example, lighting devices include universal product codes (UPCs) and unique network identifications (IDs), such as a unique network address. When the lighting devices are installed, a position of the device within the building is noted and retained. A Global Positioning System (GPS) device can aid in determining their locations.

Process 100 links (104) the pixels through a network including at least a server (e.g., network 10). As described above, the network 10 can be implemented as, for example, a LAN, a wireless LAN, or a combination of traditional LAN and wireless LAN.

Process 100 selectively controls (106) a state of each of the pixels in the network. The state can have several values. For example, a state that is “on” can be represented by a turned on interior lighting device and an open window treatment device, while a state that is “off” state can be represented by closed window treatment device. In other examples, state can represent pixels that exhibit shades of light, for example, that are generated by brightness/dimming control of the lighting devices.

Selectively controlling (106) enables a host of features. For example, pixels can be activated in response to an alert for security and/or fire alarms. Interior light animations can be used for fire guidance control/exit demarcation, alarms, signal a meeting or event, and signal an end of a meeting or event within a room or rooms. Selectively controlling (106) can provide for a gradient of lights in a conference room (e.g., front lights on, rear lights off). Selectively controlling (106) can be used in conjunction with electrochromic (or windows) in place of shades to control light emanating from a room.

In one particular example, selectively controlling (106) turns a pixel on or off. To turn a pixel on, a corresponding window treatment device is open, and a corresponding light on. To turn a pixel off, either the window treatment device is closed or the lighting device turned off.

A determination of how to put a pixel into a desired state is based on several criteria. For example, if a particular room is occupied, the lighting device must be on. This implies that the pixel state is entirely controlled by the window treatment device state. If the room has insufficient light separation (for example, an open floor plan), the pixel state must be entirely controlled by the window treatment device state. If the room is unoccupied and there is sufficient light separation, then the preference is to control the pixel state by the lighting device state. This increases pixel switching time, and decreases mechanical wear.

Using process 100 in network 10 provides for energy conservation. Energy is conserved in two ways, i.e., reducing electricity usage by turning off the lighting devices when offices are unoccupied, and reducing heating and cooling costs by controlling solar heating and cooling using window treatment device position.

Turning the lighting device off when an office is unoccupied saves energy by conserving electricity. To prevent interference with the image display aspects of the network 10, exterior lighting devices only exhibit this behavior during daylight hours. Interior lighting devices (if the network 10 is installed throughout the interior) exhibit this behavior at all times.

If the building's heating system is active, then a determination is made to the relative cost of heat from the light device verses the heating system. The lighting device is only turned off if the heating system is more efficient.

If the building cooling system is active, turning off a light device will conserve electricity directly and also further reduce energy consumption by reducing the load on the cooling system.

To a building occupant, lighting devices, window treatment devices (e.g., shade), and switching devices operate exactly as expected. When a lighting device switch is toggled, the light device turns on or off. When a window treatment device switch is toggled, the window treatment device opens or closes. These operations are very low latency. The only difference in behavior occur when the building server 14 is displaying images or conserving energy.

When displaying images, turning on a lighting device may cause a window treatment device to close. Occupant initiated closing or opening of a window treatment device may be disallowed if doing so would put the pixel in an incorrect state and a window treatment device policy is configured to prevent user overrides. Otherwise the window treatment device behaves normally and process 100 attempts to optimize the generated/displayed image. Such an override is maintained for a period of time, or until the room becomes unoccupied.

When the building server 14 is conserving energy, lighting devices turn off automatically when a room becomes unoccupied. Depending on the configuration, the lighting device may turn back on when a room is reoccupied. Window treatment devices open and close throughout the day to optimize solar heating. Occupant initiated closing or opening of a window treatment device may be disallowed if the window treatment device policy is configured to prevent user overrides. Otherwise an override is maintained for some period of time, or until the room becomes unoccupied.

During times of day where occupancy levels are high, i.e., work hours, high reliability occupancy detection can be relied on. During times of day where the occupancy level are low, heuristics and low reliability detection schemes are utilized.

To warm a building during daylight hours, particularly in the morning, the window treatment devices are opened. Similarly, to cool a building (i.e., to keep it from warming up) the window treatment devices are closed. Doing this saves energy by reducing the work of the heating and cooling systems. This strategy is only effective during daylight hours, and thus will not interfere with nighttime image display.

Solar cooling that occurs at night can also be minimized by closing all the window treatment devices, but the effect is minimal unless the window treatment devices have a very high resistance to heat flow (i.e., R value).

Determining occupancy can be done in one of many ways, such as, occupancy sensors, detection of manual switch toggle, time of day heuristics, inactivity timeout heuristics, historical bias heuristics, and screen saver heuristics.

Occupancy sensors determine occupancy through infrared and motion detection systems. Since occupancy detectors are very reliable, barring an alternative input or heuristic, the presumed occupancy of a room corresponds to the state of the occupancy sensor.

If a switch is manually toggled then the room is presumed to be occupied. This assumption continues for some period of time and then until the occupancy detector (if installed) determines otherwise. If very shortly after presuming the unoccupied state again, the switch is again manually toggled, the building server 14 will extend the period of time it waits before again presuming the unoccupied state.

The time of day has large effect on the presumption of occupancy. During working hours, it is more strongly presumed that offices are occupied. During the middle of the night it is more strongly presumed that offices are unoccupied. As the presumption of occupancy increases, the threshold used with occupancy sensors is lowered (i.e., a less reliable signal is presumed to indicate occupancy) and the occupancy timeouts are increased (i.e., if an office is presumed occupied by detection of a user event such as the manual toggle of a switch, a longer period of time is waited before the system will consider the presumption of unoccupied).

Historical events also have an effect on the presumption of occupancy. If an office has historically been occupied at certain times during the day, it will have a higher presumed occupancy at those same times during future days.

Occupancy can also be detected by installing software that detects inactivity on the computer (e.g., like a screen saver). If the screensaver activates the presumption of occupancy is decreased.

As described above, the network 10 communicates using a combination of wired and wireless networks. The wired networks can include of 10/100 base T Ethernet, Digital Subscriber Line (DSL), Data Over Cable Service Interface Specifications DOCSIS), Digital Addressable Lighting Interface (DALI), and/or standard electrical wiring. The wireless components can include one or more of the various 802.11 and cellular standards.

The network 10 can be constructed in different ways depending on the specific logistical constraints of a site. Some key issues are security, latency, bandwidth, reliability, and cost.

Security is achieved by complying with standard cryptographic practices. All communications in network 10 are encrypted and authenticated. To prevent spoofing, all devices on the network 10 are given a unique key at installation. Keys are role and location specific. Keys are rotated frequently. Physically accessible devices detect and report any access attempts.

Latency between certain devices should be very low. For example, when a lighting switch is turned on, the corresponding lighting device should turn on immediately. To guarantee this, the switch and light device communicate directly. To make this guarantee compatible with the security requirements, devices are periodically given lists of identities and encryption keys of other devices that they may communicate with.

Because of potential high latency between the centralized building server 14 and the lighting devices and window treatment devices controlled by the office controllers 16, pixel instructions are sent in large blocks to the lighting devices and window treatment devices and stored there locally. These instructions are set to run at a time in the future; a time after all the lighting devices and window treatment devices are expected to have received their instruction blocks. This insures uninterrupted and synchronized operations with network 10.

The specifics for guaranteeing sufficient bandwidth, high reliability and low cost are dependent on the physical constraints of a particular site. A large installation can be divided into many subnets. At the endpoints, the switching devices, lighting devices, and window treatment devices are networked by, for example, DALI where wiring costs are not prohibitive, or a ZigBee Network Routing Protocol where they can be prohibitive. Subnets are linked together by wired or wireless Ethernet, or Zigbee. The entire building is connected to the building server 14 through any number of wired options, or a cellular modem.

Several aspects affect the quality of a displayed image or animation, such as, for example, overall brightness, correctness of brightness, correctness of timing, and the number of mis-lit pixels.

The brighter an image, the greater its visibility. The brightness of a displayed image is dependent on the brightness of the interior office lighting devices. To maximize image brightness, many high intensity interior lighting devices are installed. If an occupant finds the interior to be too bright, he or she can simply dim the lighting device. The building server 14 remembers the desired light level and reverts to it whenever the office is determined to be occupied.

To maximize image quality any intended variance in brightness should reflect actual variance in brightness. Intended variance and actual variance may differ due to differences in room decor (e.g., paint color, or furniture layout, which alter the amount of light visible from the outside). To correct for this the verification system 40 (e.g., an external camera) compares intended variance to what is actually displayed. The camera sends signals to the building server 14 to adjust the relative baseline brightness of the affected pixels. A human operator (e.g., user 22) may also perform this operation.

Similarly for animations, all pixel transitions should occur at the same time. An external camera or operator compares expected pixel transition times with actual pixel transition times and feeds adjustments back to the building server 14.

Some pixels may not be in a desired state due to overrides from building occupants. The building server 14 may move an image up, down, or diagonally to minimize the number of mis-lit pixels. If the number of mis-lit pixels is too great, the building server 14 may select an alternative image to display.

Associating lighting devices and window treatment devices with the correct pixels and switches differs from normal light, window treatment and switch installation. As described above, each device (e.g., lighting device linked to office controller 16) has a universally unique identification (ID). During installation of network 10, the ID of each device is recorded and associated with a location in the structure (e.g., office room on a building). The device ID can be recorded by bar-code scan, or by some other automated method. The location can be recorded using, for example, GPS location, floor number, and blue print location. Switch associations are also recorded. The recorded data is checked for consistency, and the pixel associations are determined from the geometry as given by a blue print.

A second empirical method can also be used to determine pixel associations. Each device's ID can have a portion representing whether it's a switching device, window treatment device or lighting device. The network 10 first opens all the window treatment devices and turns off all the lighting devices. Next, a light device is turned on, and the outside of the building is observed to determine which pixel the lighting device is associated with. This is repeated for every lighting device. Finally, all the window treatment devices are closed, all the lighting devices are turned on and each window treatment device is actuated to determine which pixels it is associated with.

Maintenance requests are generated by the building server 14, office controllers 16, devices and user 22. The building server 14 generates requests when devices near the end of their expected life. Office controllers 16 generate requests when they detect a hardware issue (e.g., a lighting device fails). User 22 can generate a request when he/she notices that something has failed.

When a device is installed as part of maintenance, the IDs of both the new and old device are recorded and the network 10 updated accordingly.

If for some reason, a switch or pixel association is incorrect, maintenance personal can go on site and manually determine and record the correct associations.

Image design software lets user 22 design images on corporate server 12 using, for example, a computer aided design (CAD) interface. The images can be previewed from different angles and distances. Once designed, the images can be uploaded to the building server 14.

In one example, the user 22 connects to the building server 14 and is presented with a list of available images for a given building. The user 22 selects images and schedules them to run.

The verification system 40 (e.g., camera) outside the building records all the images that the building displays and uploads the recording to the building server 14. User 22 can view current and historical image data for a building.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a LAN and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other.

It is to be understood that the foregoing description is intended to illustrate and not to limit the scope of the invention, which is defined by the scope of the appended claims. Other embodiments are within the scope of the following claims.

What is claimed is:

1. A network comprising:
a corporate server linked to a building server; and
devices linked to the building server, the devices selectively controlling light emanating to an exterior of a structure from a plurality of rooms within the structure.

2. The network of claim 1 wherein the devices are window treatments.

3. The network of claim 1 further comprising devices controlling lighting fixtures integrated with the devices selectively controlling the light emanating to the exterior of the structure.

4. The network of claim 1 further comprising one or more room controllers positioned in a subset of the plurality of rooms and configured to one or more of the devices.

5. The network of claim 1 wherein the corporate server comprises an input/output (I/O) device for receipt and transmission of data.

6. The network of claim 5 wherein the corporate server further comprises a web interface.

7. The network of claim 1 wherein the corporate server comprises a graphical user interface (GUI) for receipt of data.

8. The network of claim 5 wherein the data comprises image data.

9. The network of claim 8 wherein the image data is sent as blocks of data and stored in the devices prior to activation.

10. The network of claim 8 wherein the image data represents pixels of light.

11. The network of claim 10 wherein a pixel of light represents an activated device allowing light to emanate to the exterior of the structure.

12. The network of claim 11 wherein a pixel of light further represents an activated lighting fixture.

13. The network of claim 5 wherein the data comprises:
temperature data; and
time of day data.

14. The network of claim 5 wherein the data comprises historical data.

15. The network of claim 5 wherein the data comprises alert data.

16. The network of claim 15 wherein the alert data comprises data representing an emergency condition within the structure.

17. The network of claim 3 wherein the devices include a manual override.

18. The network of claim 7 wherein the GUI comprises a computer-aided design (CAD) program.

19. The network of claim 3 wherein each of the devices operate over a range of values.

20. The network of claim 1 further comprising a verification system linked to the building server.

21. The network of claim 20 wherein the verification system comprises a camera.

22. The network of claim 21 wherein the camera is an Internet-enabled digital video camera.

23. The network of claim 22 wherein the Internet-enabled digital camera sends adjustment data to the building server in response to a comparison of expected image display and actual image display.

24. The network of claim 22 wherein the Internet-enabled digital camera sends adjustment data to the building server in response to a comparison of an expected image display time and an actual image display time.

25. The network of claim 7 wherein the GUI comprises an interface for viewing a current state of the exterior of the structure.

26. The network of claim 25 wherein the current state comprises a current image from an Internet-enabled digital video camera and statistics related to generating the current image.

27. A network comprising:
a corporate server linked to a building server; and
devices linked to the building server, the devices controlling light fixtures that emanate light to an exterior of a structure from a plurality of rooms within the structure.

28. The network of claim 27 further comprising devices controlling light emanating to the exterior and integrated with the devices controlling the light fixtures.

29. The network of claim 27 further comprising one or more room controllers positioned in a subset of the plurality of rooms and configured to control one or more devices.

30. The network of claim 27 wherein the corporate server comprises an input/output (I/O) device for receipt and transmission of data.

31. The network of claim 30 wherein the corporate server further comprises a web interface.

32. The network of claim 27 wherein the corporate server comprises a graphical user interface (GUI) for receipt of data.

33. The network of claim 30 wherein the data comprises image data.

34. The network of claim 33 wherein the image data represents pixels of light.

35. The network of claim 34 wherein the image data is sent as blocks of data and stored in the devices prior to activation.

36. The network of claim 34 wherein a pixel of light represents an activated device allowing light to emanate to the exterior of the structure.

37. The network of claim 36 wherein a pixel of light further represents an activated lighting fixture.

38. The network of claim 30 wherein the data comprises:
temperature data; and
time of day data.

39. The network of claim 30 wherein the data comprises historical data.

40. The network of claim 30 wherein the data comprises alert data.

41. The network of claim 40 wherein the alert data comprises data representing an emergency condition within the structure.

42. The network of claim 28 wherein the devices include a manual override.

43. The network of claim 30 wherein the GUI comprises a computer-aided design (CAD) program.

44. The network of claim 28 wherein the devices operate over a range of values.

45. The network of claim 27 further comprising a verification system linked to the building server.

46. The network of claim 45 wherein the verification system comprises a camera.

47. The network of claim 46 wherein the camera is an Internet-enabled digital video camera.

48. The network of claim 47 wherein the Internet-enabled digital camera sends pixel adjustment data to the building server in response to a comparison of expected brightness information and actual brightness information.

49. The network of claim 32 wherein the GUI comprises an interface for viewing a current state of the exterior of the structure.

50. The network of claim 49 wherein the current state comprises a current image from an Internet-enabled digital video camera and statistics related to generating the current image

51. A network comprising:
a corporate server linked to a building server;
devices linked to the building server, a first set of the devices selectively controlling room light emanating to an exterior of a structure from a plurality of rooms within the structure; and
a second set of devices selectively controlling lighting fixtures within the plurality of rooms, the first set of devices integrated with the second set of devices.

52. The network of claim 51 wherein the first set of devices are window treatments.

53. The network of claim 52 further comprising one or more room controllers positioned in a subset of the plurality of rooms and configured to control one or more devices.

54. The network of claim 51 wherein the corporate server comprises an input/output (I/O) device for receipt and transmission of data.

55. The network of claim 54 wherein the corporate server further comprises a web interface.

56. The network of claim 51 wherein the corporate server comprises a graphical user interface (GUI) for receipt of data.

57. The network of claim 54 wherein the data comprises image data.

58. The network of claim 57 wherein the image data represents pixels of light.

59. The network of claim 58 wherein the image data is sent as blocks of data and stored in the devices prior to activation.

60. The network of claim 58 wherein a pixel of light represents an activated device allowing light to emanate to the exterior.

61. The network of claim 60 wherein a pixel of light further represents an activated lighting fixture.

62. The network of claim 54 wherein the data comprises:
temperature data; and
time of day data.

63. The network of claim 54 wherein the data comprises historical data.

64. The network of claim 54 wherein the data comprises alert data.

65. The network of claim 64 wherein the alert data comprises data representing an emergency within the structure.

66. The network of claim 51 wherein the devices include a manual override.

67. The network of claim 54 wherein the input/output device comprises a computer-aided design (CAD) program.

68. The network of claim 51 wherein the devices operate over a range of values.

69. The network of claim 51 further comprising a verification system linked to the building server.

70. The network of claim 69 wherein the verification system comprises a camera.

71. The network of claim 70 wherein the camera is an Internet-enabled digital video camera.

72. The network of claim 71 wherein the Internet-enabled digital camera sends adjustment data to the building server in response to a comparison of expected image display and actual image display.

73. The network of claim 54 wherein the input/output device comprises an interface for viewing a current state of the exterior of the structure.

74. The network of claim 73 wherein the current state comprises a current image from an Internet-enabled digital video camera and statistics related to generating the current image

75. A method comprising:
in a network comprising a server linked to a plurality of office controllers, the office controllers positioned within a subset of rooms within a structure and linked to one or more devices positioned in a set of rooms, assigning the office controllers as pixels; and
selectively controlling a state of each of the pixels in the network.

76. The method of claim 75 wherein an “on” state of a pixel comprises an activated lighting device and an activated window treatment device.

77. The method of claim 75 further comprising previewing an image caused by the pixels in a graphical user interface (GUI).

78. The method of claim 75 further comprising storing historical information pertaining to an image caused by the pixels.

79. The method of claim 78 wherein the historical information includes scheduling information and billing information.

80. The method of claim 77 wherein the GUI comprises computer-aided design (CAD) software.

81. The method of claim 75 further comprising alternating a display of an image on an exterior of the structure upon input from a verification system.

82. The method of claim 81 wherein the verification system is an Internet-enabled digital camera.

83. The method of claim 82 wherein the Internet-enabled digital camera sends pixel adjustment data to the building server in response to a comparison of expected pixel transition times and actual pixel transition times.

84. The method of claim 81 wherein the building server comprises pattern recognition software.

85. The method of claim 75 further comprising controlling the state in response to determining an occupancy of each of the rooms associated with the office controllers.

86. The method of claim 75 further comprising controlling the state in response to determining an alert triggered by the associated office controllers.

87. The method of claim 86 wherein the alert is a security alarm.

88. The method of claim 86 wherein the alert is a fire alarm.

89. The method of claim 75 further comprising controlling the state in response to temperature data generated by the associated office controllers.

90. The method of claim 75 further comprising controlling the state in response to historical data.

91. The method of claim 75 wherein selectively controlling the state of each of the pixels in the network includes detecting an occupancy.

92. The method of claim 75 further comprising manually overriding the state.

93. The method of claim 75 wherein selectively controlling the state of each of the pixels in the network comprises scheduling information.

94. The method of claim 75 wherein selectively controlling the state of each of the pixels in the network comprises:
detecting faults in the pixels; and
altering positions of the pixels to compensate for detected faults.

95. A method for generating an image from a building, the image including pixels, the method comprising:
generating signals associated with the pixels;
sending the signals to offices in the building, an office corresponding to one or more of the pixels, the offices including lighting devices configured to emit light and to receive the signals; and
controlling the light emitted from the lighting devices to the exterior of the building based on the signals.

96. The method of claim 95 wherein the signals are sent in blocks and stored in the devices prior to activation.

97. The method of claim 95 wherein controlling the light comprises turning on or turning off or dimming the lighting devices.

98. The method of claim 95 wherein the lighting devices comprise window covering devices configured to emit light and to receive the signals, and controlling the light comprises opening or closing the window coverings based on the signals.

99. The method of claim 98 wherein the window covering devices are electronic shades.

100. The method of claim 98 wherein the window covering devices are electronic blinds.

101. The method of claim 95 wherein the signals comprise electrical signals.

102. The method of claim 95 wherein the signals comprise radio signals.

103. The method of claim 95 further comprising:
receiving an input to override the signals; and
preventing the signals from being executed based on the input.

104. The method of claim 95 wherein the input is based on sensing office occupancy.

105. The method of claim 95 wherein the input is made by a user.
